(19) United States
(12) Patent Application Publication
(10) Pub. No.: US 2015/0066920 A1
(43) Pub. Date: Mar. 5, 2015

(54) MEDIA CLIP SHARING ON SOCIAL NETWORKS

(71) Applicant: Google Inc., Mountain View, CA (US)

(72) Inventor: Scott Eric Barta, Los Altos, CA (US)

(73) Assignee: Google Inc., Mountain View, CA (US)

(21) Appl. No.: 14/017,468

(22) Filed: Sep. 4, 2013

(51) Int. Cl. G06F 17/30

(52) U.S. Cl. CPC G06F 17/3089
USPC 707/726

(57) ABSTRACT

Systems and techniques are disclosed for creating and sharing short, customized media clips on social networks. The system can perform media content analysis (i.e., facial recognition, audio recognition, etc.) on a media. The system can generate metadata associated with the media content based on the media content analysis. A user can submit a search query for characteristics of the media content. The system can perform a search on the generated metadata based on the received search query. The system can return identified portions of the media content that satisfy the search on the generated metadata. A short, customized clip created from the identified portions of the media content can be shared to a social media network.

### BACKGROUND

A media that is provided to a user may contain information that the user would like to share with other users. In particular, the user may wish to share one or more portions of the media with members of the user's social network. Such sharing can broaden awareness and interaction of users with the media.

### BRIEF SUMMARY

According to implementations of the disclosed subject matter, a first media content can be received. A media content analysis can be performed on at least a portion of the first media content. Metadata can be generated based on the results of the media content analysis. A search query can be received and a search can be conducted of the generated metadata based on the search query. At least one portion of the first media content can be identified based on the results of the search of the generated metadata. An instruction can be received to create a second media content based on the identified at least one portion of the first media content. The second media content can include at least part of the identified at least one portion of the first media.

An implementation of the disclosed subject matter may include a processor that is configured to receive a first media content. In an implementation, the processor may be configured to perform a media content analysis on at least a portion of the first media content. The processor may further be configured to generate metadata based on the results of the media content analysis. The processor may also be configured to receive a search query and conduct a search of the generated metadata based on the search query. At least one portion of the first media content can be identified based on the results of the search of the generated metadata. The processor may be configured to receive an instruction to create a second media content based on the identified at least one portion of the first media content. The second media content can include at least part of the identified at least one portion of the first media.

Systems and techniques according to the present disclosure allow for the creation of a short, custom clip for sharing with a user's social network. The system can generate metadata associated with the media to allow the user to query the media for relevant content to include in the clip. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows a method according to an implementation of the disclosed subject matter.

FIG. 4 shows an example of a second media such as a custom clip that is created from a first media.

### DETAILED DESCRIPTION

Implementations in accordance with the disclosed subject matter may perform media content analysis on a first media, associate generated metadata to the first media, identify relevant portions of the media based on a user search query of the metadata, and receive instructions to create a short clip based on the results of the search of the metadata.

For example, a user may desire to compile a short clip of all of the occurrences of an actor reciting funny quotes in a video. An implementation in accordance with the disclosed subject matter may receive the full-length video and perform an analysis to detect both the actor and the content of the actor's speech. The implementation may then generate metadata based on the results of this video analysis and associate the metadata with the video. The user can query the metadata to identify portions of the video that contain the actor and also contain specific speech from the actor. The implementation may then receive instructions to create a short clip based on the one or more identified portions of the video that satisfy the search query of the metadata.

As another example, a user may desire to compile a short clip of all of the occurrences of a specific phrase in a recording of a presidential speech that is presented in an audio program along with commentary by a narrator. An implementation in accordance with the disclosed subject matter may receive the full-length audio and perform an analysis to detect speech elements uttered by the president and the narrator. The implementation may then generate metadata based on this audio analysis and associate the metadata with the recording. The user can query the metadata to identify portions of the audio that contain words, phrases or topics of interest uttered by the president and/or the narrator. The implementation may then receive instructions to create a short clip based on the identified portions of the audio that satisfy the search query of the metadata. The clip may include different segments from the full-length audio. The segments may contain audio by the president, audio by the narrator or both.

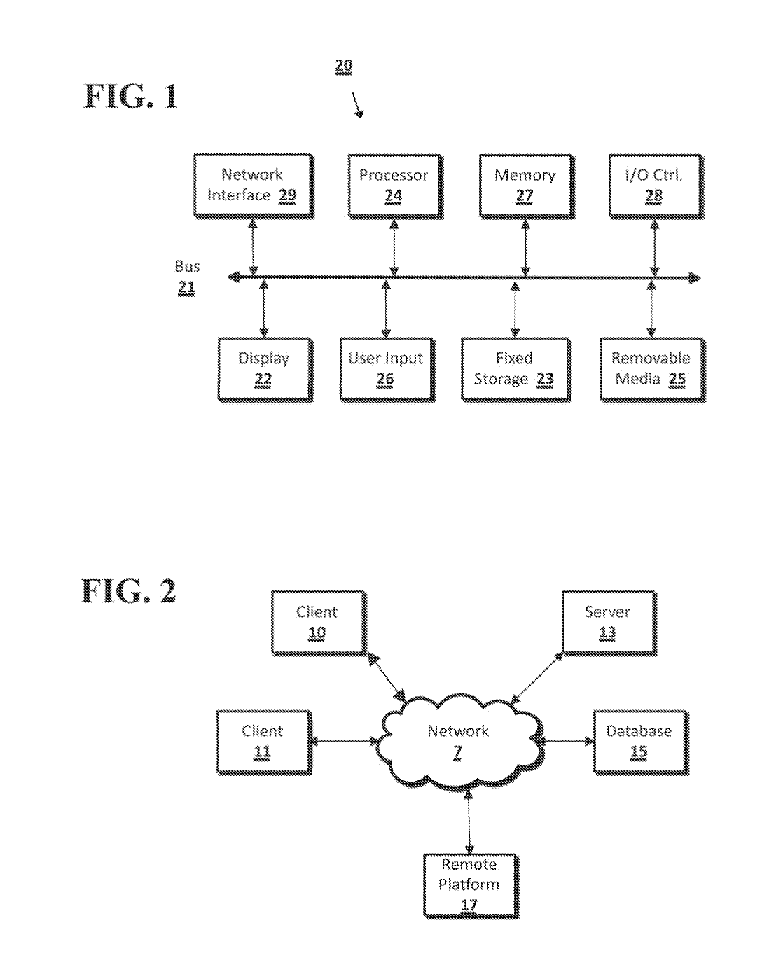

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) that controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

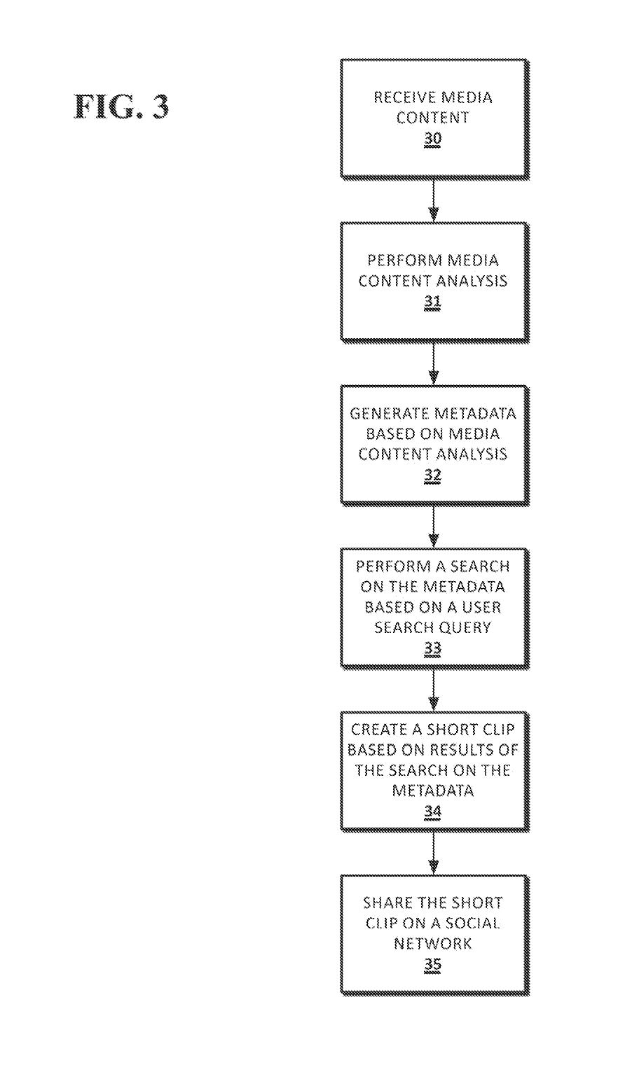

As shown in FIG. 3, an implementation may receive media content, step 30, and perform a media content analysis, step 31. The implementation can generate metadata and associate it with the media, step 32. Based on a user search query, the implementation performs a search on the generated metadata, step 33. The implementation may then receive an instruction from the user to create a short clip based on the results of the search query, step 34. The short clip may be shared to the user's social network, step 35.

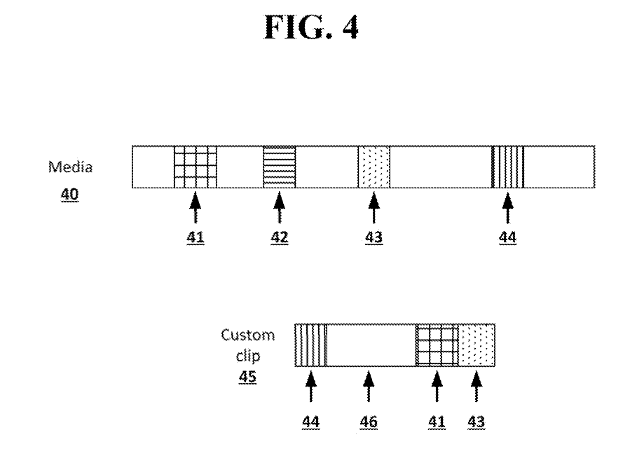

As shown in FIG. 4, an implementation may identify portions, 41, 42, 43, and 44, of a media, 40, that satisfy a search query of the generated metadata from a user. The implementation may then receive instruction to create a custom clip, 45, based on the portions of the media that satisfy the search query of the metadata. The user can specify which portions should be used in a custom clip and in which order. Also, the user may be able to include other content (e.g., from other media, advertisements, user-generated material, etc.) into the custom clip. Custom clip 45 includes portions 41, 43 and 44 along with user-generated portion 46.

According to an implementation of the disclosed subject matter, a first media may be received from a user, received from a third party, received (e.g., retrieved) from a database accessible to the implementation, etc. Examples of media include video content, music content, speech content, image content, and print (i.e., newspapers, magazines, etc.). The media content may be received directly or through a link. The link may be received from a user or detected by the implementation in a received file, such as a playlist or a media file. A link may include a pointer to a link, a URL address, an XML link, and an HTTP link. The implementation may then send a request to receive the media based on the media link. The implementation may also authenticate a user credential to access the media or pass along such a credential to a content manager.

An implementation of the disclosed subject matter may perform media content analysis on at least a portion of the received media. The analysis may include facial recognition, audio recognition, speech recognition, object recognition, and text recognition. The analysis can further determine an attribute of the media based on the analysis. For example, the analysis may determine attributes such as the identity of an actor who appears in the media (e.g., based on facial recognition analysis), that a particular song exists in the media (based upon music recognition analysis), that a keyword or phrase is uttered in the media (based on a speech recognition analysis), that a type of car is shown in the media (based on image analysis), etc. Likewise, a media may include searchable speech captions. Alternatively, the implementation may perform its own machine-based speech analysis to generate speech-based metadata. Also, the implementation may perform automated song recognition analysis to identify music in a scene and may analyze and identify secondary audio in the clip. An example of secondary audio is audio associated with a television show being watched by characters included in a clip. The analysis could identify the show being watched by the characters, the scene of the show being watched by the characters, the topic, speech content, etc. An attribute may be associated with a particular location/time/segment within the media.

In an implementation of the disclosed subject matter, metadata may be generated as a result of the media content analysis and the determination of an attribute. Examples of metadata may include a character instance, an object instance (i.e., a vehicle instance (e.g., a make and model of a particular car)), an article of clothing instance (a specific brand of dress shoe), etc.), a part of speech instance (a catch phrase), a musical instrument instance, a dialogue instance, and a shape instance. The implementation may further associate the generated metadata with at least a portion of the media. For example, a yellow, compact car may appear at unique and distinct portions of a video. The implementation may then generate metadata (a descriptor that can include an item identifier, descriptive text, etc.) signaling the appearance of the car and associate the generated metadata with the portions of the video where the car appears. Image analysis can produce metadata describing a branded product, instances of a traditional product placement of consumer goods, automobiles, etc., designers of clothing and furniture shown in the clip, a real-world location used as in a clip, species and breeds of plants and animals (e.g. to help find a clip that includes a particular actor with a specific type of dog), time and place information, colors information, etc.

An implementation of the disclosed subject matter may receive a search query from a user. The search query may include actor information, scene information, dialog information, music information, object information, shape information, scene information such as types of camera angles and shots such as tripod shots, handheld, dolly shots, crane shots, aerial shots, medium shots, close-ups and extreme-close-ups and a segment attribute relevant to the media content. Also, the user may query for a popular segment or a segment that has received a high rating. For example, a segment of a first media may have a popularity rating that can be used as the basis for providing the segment. Other examples of data external to the media that would be useful to the implementation can include all of the media mentioned by a given blogger, all media that have had more than a certain number of views, shares or like on content sharing or social media, media available or not available from a given source, etc.

In an implementation of the disclosed subject matter, a search on the generated metadata may be conducted based on a received search query. For example, if the received search query includes the word “basketball”, the search on the generated metadata may include searching for a round, orange object. If the received search query includes an image, the search on the generated metadata may implement an image-matching algorithm.

An implementation of the disclosed subject matter may identify at least one portion of the media content relevant to the results of the search of the generated metadata. The identified at least one portion may include an actor relevant to the search query, a scene relevant to the search query, a dialog relevant to the search query, a music relevant to the search query, an object relevant to the search query, a shape relevant to the search query, a first media content attribute relevant to the search query, and a highly rated scene relevant to the search query.

Having identified at least one portion of the media relevant to the search, an implementation can display information about the identified portions to the user, or show the identified portions themselves. Based on the identified portions, the user may select, edit, and compose at least one of the identified portions into a second media such as a custom clip. The implementation may receive the user's instructions to create the custom clip. The second media may inherit certain attributes of the first media from which it derived. Such attributes may include a media title, a media description, a media duration, a media credits information, a description, a link to the first media, a link to purchase the first media, etc.

In another implementation of the disclosed subject matter, the second media may be created automatically based on the results of the search query. For example, if the implementation receives a search query containing the word “boat”, the implementation can search the generated metadata for instances where a boat-shaped object appeared. If the implementation determined four seven-second portions where a boat-shaped object appeared, the implementation would compile the second media out of the 4 portions resulting in a 28 second segment. The second media may inherit certain attributes of the first media from which it derived. Such attributes may include a media title, a media description, a media duration, a media credits information, a description, a link to the first media, a link to purchase the first media, etc.

The implementation may send the second media and/or attributes of the second media to a social network. Such attributes may include a media title, a media description, a media duration, a media credits information, a description, a link to the first media, and a link to purchase the first media.

In another implementation, one or pointers may be sent to a social network. Each pointer, for example, may refer to a portion start point or a portion stop point of the first media or an identifier of a preselected second media. Likewise, a pointer may refer to a custom clip stored at a remote location. These pointers may be used by the social network to compose and/or provide the second media to users of the social network. Such pointers can operate similarly to a playlist, where the identified segments are portions of the first media.

An implementation of the disclosed subject matter may receive a comment or additional description that is associated with the second media. The comment or additional description may be associated with the second media and/or posted to the social network along with the sharing of the second media content to the social network.

An advertisement may also be included in or along with the second media. The advertisement can be selected based on metadata associated with the first media, metadata associated with the second media, the content of the user search query, the results of the search query, browsing history of the user sharing the second media to the social network, browsing history of a user in the social network of the sharing user, etc. For example, it may be determined that the first media includes a red motorcycle, the search query includes a reference to a red motorcycle, and the second media includes a red motorcycle. The implementation may include an advertisement for a red motorcycle in the second media or may send a pointer to the same to the social network or to a user that is a member of the sharing user's social network. The social network may also select and provide such an advertisement based on at least some of these factors.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a first media content;
performing a media content analysis on at least a portion of the first media content;
generating a metadata based on the media content analysis;
receiving a search query;
conducting a search of the generated metadata based on the search query;
identifying a plurality of portions of the first media content based on the results of the search of the generated metadata; and
receiving an instruction to create a second media content based on the identified plurality of portions of the first media content, the instruction identifying two or more of the plurality of portions of the first media content to be used in the second media content and an order in which the two or more of the plurality of portions of the first media content are to be presented in the second media content, wherein the second media content is a clip, and wherein the second media content is a subset of the first media content.

2. The method of claim 1, further comprising:
receiving a link to the first media content and sending a request based on the received link.

3. The method of claim 1, wherein the step of performing the media content analysis on at least a portion of the first media content includes at least one from the group consisting of:
performing a facial recognition, performing a pattern recognition, performing an audio recognition, performing an object recognition, and performing a text recognition, and determining a media content attribute.

4. The method of claim 1, wherein the step of receiving a search query includes receiving at least one from the group consisting of:
actor information, scene information, dialog information, music information, object information, shape information, a segment attribute, a popularity indicator and a rating indicator.

5. The method of claim 1, further comprising:
sending at least one portion of the first media content based on the results of the search of the generated metadata, wherein the portion includes at least one from the group consisting of:
an actor relevant to the search query, a scene relevant to the search query, a dialog relevant to the search query, a music relevant to the search query, an object relevant to the search query, a shape relevant to the search query, a first media content attribute relevant to the search query, a highly rated scene relevant to the search query.

6. The method of claim 1, further comprising:
sending the second media content to a social network.

7. The method of claim 1, further comprising:
receiving a comment associated with the second media content and sending the comment associated with the second media content to a social network.

8. The method of claim 6, wherein the step of sending the second media content consists of sending at least one from the group of:
a segment start point, a segment stop point, an identifier of a preselected segment, an advertisement, and segment content.

9. The method of claim 6, wherein the sending the second media content comprises:
sending at least one from the group consisting of: a title, a duration, credits information, a description, a link to a trailer, a link to purchase, and popularity data.

10. The method of claim 6, further comprising:
selecting second media content based on the first media content and sending the second media content to the social network.

11. A system comprising:
a memory;
a processor in connection with the memory, the processor configured to:
receive a first media content;
perform a media content analysis on at least a portion of the first media content;
generate a metadata based on the media content analysis;
receive a search query;
conduct a search of the generated metadata based on the search query;
identify a plurality of portions of the first media content based on the results of the search of the generated metadata; and
receive an instruction to create a second media content based on the identified plurality of portions of the first media content, the instruction identifying two or more of the plurality of portions of the first media content to be used in the second media content and an order in which the two or more of the plurality of portions of the first media content are to be presented in the second media content, wherein the second media content is a clip and wherein the second media content is a subset of the first media content.

12. The system of claim 11, wherein the processor is further configured to:
receive a link to the first media content and send a request based on the received link.

13. The system of claim 11, wherein the processor is further configured to:
perform the media content analysis on at least a portion of the first media content.

14. The system of claim 13, wherein the processor is further configured to:
perform at least one from the group consisting of:
facial recognition, pattern recognition, audio recognition, object recognition, and text recognition.

15. The system of claim 11, wherein the processor is further configured to: determine a media content attribute.

16. The system of claim 11, wherein the processor is further configured to:
receive a search query of at least one from the group consisting of:
an actor information, a scene information, a dialog information, a music information, an object information, a shape information, a segment attribute, a popularity indicator, and a rating indicator.

17. The system of claim 11, wherein the processor is further configured to:
send at least one portion of the first media content based on the results of the search of the generated metadata, wherein the portion includes at least one from the group consisting of:
an actor relevant to the search query, a scene relevant to the search query, a dialog relevant to the search query, a music relevant to the search query, an object relevant to the search query, a shape relevant to the search query, a first media content attribute relevant to the search query, a highly rated scene relevant to the search query.

18. The system of claim 11, wherein the processor is further configured to:
send the second media content to a social network.

19. The system of claim 11, wherein the processor is further configured to:
receive a comment associated with the second media content and to send the comment associated with the second media content to a social network.

20. The system of claim 18, wherein the processor is further configured to:
send the second media content including at least one from the group consisting of:
a segment start point, a segment stop point, an identifier of a preselected segment, an advertisement and segment content.

21. The system of claim 18, wherein the processor is further configured to:
send the second media content including at least one from the group consisting of:
a title, a duration, credits information, a description, a link to a trailer, a link to purchase, and popularity data.

22. The method of claim 1, wherein the second media content comprises at least two non-subsequent portions of the first media content.
